(19) United States
(12) Patent Application Publication
(10) Pub. No.: US 2006/0018250 A1
(43) Pub. Date: Jan. 26, 2006

(54) Apparatus and method for transmitting and receiving a signal in an orthogonal frequency division multiplexing system

(76) Inventors: Young-Mo Gu, Suwon-si (KR); Min-Goo Kim, Yongin-si (KR); Sung-Soo Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/185,968

(22) Filed: Jul. 21, 2005

(30) Foreign Application Priority Data
Jul. 21, 2004 (KR) 2004-56884

(51) Int. Cl. H04J 11/00

(52) U.S. Cl. 370/208

(57) ABSTRACT

A system and method for effectively providing an adaptive modulation scheme and known-cyclic prefix (CP) technology in an orthogonal frequency division multiplexing (OFDM) communication system. An OFDM transmission system variably generates a known CP while considering a channel state. Pilot subcarrier position information for generating the known CP is sent to a transmitter. Pilot subcarriers are selected on the basis of a channel state of an OFDM symbol through which data is transmitted and the known CP is generated, such that data transmission is provided efficiently.

### PRIORITY

This application claims the benefit under 35 U.S.C. § 119(a) of an application entitled “Apparatus and Method for Transmitting and Receiving a Signal in an Orthogonal Frequency Division Multiplexing System” filed in the Korean Intellectual Property Office on Jul. 21, 2004 and assigned Serial No. 2004-56884, the entire contents of which are incorporated herein by reference.

### BACKGROUND OF THE INVENTION

1. Field of the Invention

The present invention generally relates to a multicarrier transmission system and method for performing adaptive modulation using a known cyclic prefix (CP) in an orthogonal frequency division multiplexing/code division multiple access (OFDM/CDMA) communication system.

2. Description of the Related Art

Conventionally, an orthogonal frequency division multiplexing/code division multiple access (OFDM/CDMA)-communication system transmits high-speed data through a radio channel and uses a plurality of carriers that are orthogonal to each other.

An OFDM scheme has been adopted in wireless standards such as the digital audio broadcasting (DAB) standard, the digital video broadcasting-terrestrial (DVB-T) standard, the Institute of Electrical & Electronic Engineers (IEEE) 802.11a local area network (LAN) standard, and the IEEE 802.16a metropolitan area network standard. Accordingly, the OFDM scheme is currently being considered as a representative scheme for future use in fourth generation (4G) mobile communication systems and next generation mobile communication systems.

OFDM transmission is performed in an OFDM symbol unit. When an OFDM symbol is transmitted through a multipath channel, the currently transmitted symbol may be affected by a previously transmitted symbol. To mitigate interference between OFDM symbols, a guard interval (GI) longer than the maximum delay spread of a channel is inserted between successive symbols. That is, an OFDM symbol period is a sum of an effective symbol interval in which actual data is transmitted and a GI. A receiver detects and demodulates data associated with the effective symbol interval after removing the GI.

To prevent orthogonality from being destroyed due to delay of a subcarrier, a signal of the last part of the effective symbol interval is copied and inserted, and the copied and inserted signal is referred to as the cyclic prefix (CP).

FIGS. 1A and 1B are block diagrams illustrating the structures of a transmitter and receiver for transmitting and receiving a multicarrier signal using a conventional adaptive modulation scheme.

In FIG. 1A, an encoder 100 of the transmitter receives an input of a data symbol to be configured by spread N-sample data, spreads the input data symbol using a code with a rate that is a multiple of N, and outputs the spread data symbol. A modulator 102 modulates the spread data symbol, and a serial to parallel (S/P) converter 104 converts the modulated spread data symbol into N-sample data.

A null inserter 120 processes a pilot subcarrier, not transmitted due to a bad channel state, as null information in feedback information selected from the receiver. That is, the null inserter 120 sets a value of a subcarrier serving as noise to 0 according to a channel estimation result.

A multiplexer (MUX) 106 receives and multiplexes the selected null information and the output of the S/P converter 104. That is, the multiplexer 106 multiplexes a subcarrier for transmitting data and a subcarrier for transmitting null information and then outputs the multiplexed subcarriers to an inverse fast Fourier transform (IFFT) processor 108 in a parallel fashion. The IFFT processor 108 receives the N-sample data output from the S/P converter 104, performs IFFT, that is, OFDM modulation, and outputs OFDM-modulated data of N samples in parallel fashion.

A parallel to serial (P/S) converter 110 receives the parallel OFDM sample data from the IFFT processor 108, converts the received data in a serial fashion, and outputs the serial data. A GI inserter 112 receives the serial OFDM sample data, copies OFDM data of the last G samples in the OFDM symbol data of an OFDM symbol configured by the OFDM data of N samples, inserts the copied sample data, that is, the OFDM data of the last G samples, into a head part of the OFDM symbol, and outputs the OFDM symbol. Hereinafter, an OFDM symbol into which a GI has been inserted is referred to as an OFDM transmission symbol.

The OFDM transmission symbol output from the GI inserter 112 is converted into an analog signal, and then the analog signal (hereinafter, referred to as the OFDM signal) is transmitted through a multipath channel.

In relation to the operation of the above-described transmitter, an analog to digital (A/D) converter (not illustrated) in the receiver of FIG. 1B receives the analog OFDM signal and converts the analog OFDM signal into a digital OFDM transmission symbol.

A GI remover 114 receives the digital OFDM transmission symbol, removes a GI from the OFDM transmission symbol, and outputs an OFDM symbol. A serial to parallel (S/P) converter 116 receives the OFDM symbol output from the GI remover 114, separates the received OFDM symbol into OFDM data of N samples, and outputs the OFDM data of N samples in the parallel fashion. A fast Fourier transform (FFT) processor 118 receives the N-sample data input in the parallel fashion, performs FFT, that is, OFDM demodulation, and outputs the demodulated N-sample data. A parallel to serial (P/S) converter 130 converts the demodulated N-sample data in the serial fashion and then outputs the converted data in a symbol unit. A demodulator 122 receives and demodulates a data symbol output from the P/S converter 130. A decoder 124 decodes the demodulated data symbol and identifies actual data. A channel measurer 126 measures a channel state of the N-sample data output through the FFT processor 118. Accordingly, a subcarrier selector 128 selects M subcarriers in which a signal to noise ratio (SNR) is relatively low using the measured result of the channel measurer 126 and then feeds back information of the selected subcarriers to the transmitter.

In response to the feedback information, the transmitter transmits subcarriers at different modulation levels using characteristics of different SNRs of the subcarriers. That is, the transmitter performs high-level modulation such as, for example, 64-quadrature amplitude modulation (64QAM) on a subcarrier with a high SNR and performs low-level modulation such as, for example, quadrature phase shift keying (QPSK) on a subcarrier with a low SNR. Transmission using an adaptive modulation scheme minimizes the probability of bit error and improves the performance of the transmitter.

A relatively high SNR gain for a transmitted signal can be obtained. However, no data is transmitted on subcarriers processed as null. There is a problem in that an amount of data to be transmitted is reduced. The receiver measures a SNR of each subcarrier and feeds back the measured SNR to the transmitter, resulting in an increased amount of feedback information.

FIG. 2 illustrates multicarrier signals successively transmitted using a known CP.

Referring to FIG. 2, a multicarrier transmission scheme using the known CP uses a fixed value in the last P samples x(N−P),x(N−P−1), . . . ,x(N−1) among N samples x(0), x(1), . . . ,x(N−1) configuring each OFDM symbol. That is, all OFDM symbols have the same value of the last P samples. In the successive OFDM symbols, a value of the last P samples of a previous OFDM symbol is the same as that of the last P samples of the current OFDM symbol. Because the last P samples serves as a GI, an additional GI does not need to be inserted. As illustrated in FIG. 2, a repeated known CP uses a superior pseudo random noise (PN) sequence with superior correlation characteristics in order to maximize the performance of synchronization detection of the receiver.

That is, the multicarrier transmission scheme using a known CP does not need to insert a GI on the time axis, but must use P subcarriers as pilot subcarriers on the frequency axis to set the value of the last P samples to be the same between all OFDM symbols. Accordingly, the number of subcarriers is 2N, and an IFFT size and an FFT size is N, respectively. When the output of the modulator is X(0),X(1), . . . ,X(N−1), the output of the IFFT processor is expressed as shown in Equation (1):

$$x ( n ) = \frac{1}{N} {\sum }_{k \neq iM - 1 ( i = 1 , … , p )}^{N - 1} X ( k ) {ⅇ}^{j \frac{2 π nk}{N}} + \frac{1}{N} {\sum }_{i = 1}^{P} X ( iM - 1 ) {ⅇ}^{j \frac{2 π n ( iM - 1 )}{N}} , n = 0 , 1 , … , N - 1 \qquad Equation ( 1 )$$

In Equation (1), M=N/P and P subcarriers X(M−1), X(2M−1), . . . , X(PM−1) are pilot subcarriers. Because the P subcarriers are associated with P CP elements, Equation (1) can be rewritten as shown in Equation (2) for n=N−P,N−P+1, . . . ,N−1:

$$x ( n ) - \frac{1}{N} {\sum }_{k \neq iM - 1 ( i = 1 , … , p )}^{N - 1} X ( k ) {ⅇ}^{j \frac{2 π nk}{N}} = \frac{1}{N} {\sum }_{i = 1}^{P} X ( iM - 1 ) {ⅇ}^{j \frac{2 π n ( iM - 1 )}{N}} , n = N - P , … , N - 1 \qquad Equation ( 2 )$$

When Equation (2) is expressed in a matrix, Equation (3) is produced:

$$[ \begin{matrix}\begin{matrix}x ( N - P ) - {x}^{′} ( N - P ) \\ ⋮\end{matrix} \\ x ( N - 1 ) - {x}^{′} ( N - 1 )\end{matrix} ] = \frac{1}{N} [ \begin{matrix}{ⅇ}^{j \frac{2 π ( N - P ) ( M - 1 )}{N}} & ⋯ & {ⅇ}^{j \frac{2 π ( N - P ) ( PM - 1 )}{N}} \\ ⋮ & ⋰ & ⋮ \\ {ⅇ}^{j \frac{2 π ( N - 1 ) ( M - 1 )}{N}} & ⋯ & {ⅇ}^{j \frac{2 π ( N - 1 ) ( PM - 1 )}{N}}\end{matrix} ] [ \begin{matrix}X ( M - 1 ) \\ ⋮ \\ X ( PM - 1 )\end{matrix} ] \qquad Equation ( 3 )$$

In Equation (3), x′(n) is expressed as follows:

$${x}^{′} ( n ) = \frac{1}{N} {\sum }_{{k \neq iM - 1 ( i = 1 , … , p )}^{k = 0}}^{N - 1} X ( k ) {ⅇ}^{j \frac{2 π nk}{N}} , n = 0 , 1 , … , N - 1 \qquad Equation ( 4 )$$

When an inverse matrix of a P×P square matrix in the right term of Equation (3) is used, the P pilot subcarriers X(M−1),X(2M−1), . . . ,X(PM−1) for generating a known CP can be obtained as shown in Equation (5):

$$[ \begin{matrix}X ( M - 1 ) \\ ⋮ \\ X ( PM - 1 )\end{matrix} ] = {N [ \begin{matrix}{ⅇ}^{j \frac{2 π ( N - P ) ( M - 1 )}{N}} & ⋯ & {ⅇ}^{j \frac{2 π ( N - P ) ( PM - 1 )}{N}} \\ ⋮ & ⋰ & ⋮ \\ {ⅇ}^{j \frac{2 π ( N - 1 ) ( M - 1 )}{N}} & ⋯ & {ⅇ}^{j \frac{2 π ( N - 1 ) ( PM - 1 )}{N}}\end{matrix} ]}^{- 1} \\ [ \begin{matrix}\begin{matrix}x ( N - P ) - {x}^{′} ( N - P ) \\ ⋮\end{matrix} \\ x ( N - 1 ) - {x}^{′} ( N - 1 )\end{matrix} ] \qquad Equation ( 5 )$$

As described above, an adaptive modulation scheme for use in the conventional multicarrier system inserts a GI on the time axis and transmits either no data or only small bit information on subcarriers in which a frequency response magnitude of a channel is small in a designated position on the frequency axis. Therefore, there is a problem in that data transmission performance is reduced.

Moreover, because the conventional multicarrier system using a known CP does not need to insert a GI on the time axis but must insert pilot subcarriers only in a designated position on the frequency axis, it is not more efficient than other conventional multicarrier systems.

### SUMMARY OF THE INVENTION

Accordingly, the present invention has been designed to solve the above and other problems occurring in the prior art. Therefore, it is an aspect of the present invention to provide a system and method for effectively providing an adaptive modulation scheme and known-cyclic prefix (CP) technology in an orthogonal frequency division multiplexing (OFDM) mobile communication system.

It is another aspect of the present invention to provide a system and method for generating a known cyclic prefix (CP) while considering a channel state in an orthogonal frequency division multiplexing (OFDM) transmission system.

It is another aspect of the present invention to provide a system and method for selecting pilot subcarriers to variably generate a known cyclic prefix (CP) while considering a channel state in an orthogonal frequency division multiplexing (OFDM) transmission system.

It is yet another aspect of the present invention to provide a system and method for feeding back position information of pilot subcarriers to generate a known cyclic prefix (CP) while considering a channel state in an orthogonal frequency division multiplexing (OFDM) transmission system.

The above and other aspects of the present invention can be achieved by a method for transmitting a signal in an orthogonal frequency division multiplexing (OFDM) communication system, comprising the steps of assigning pilot subcarriers corresponding to P subcarriers in which a signal to noise ratio (SNR) is relatively low among N subcarriers, where N is an integer greater than 1 and P is an integer less than N; and performing inverse fast Fourier transform (IFFT) and transmission after mapping the pilot subcarriers to a pilot symbol and mapping remaining subcarriers to a data symbol.

The above and other aspects of the present invention can also be achieved by a method for receiving a signal in an orthogonal frequency division multiplexing (OFDM) communication system, comprising the steps of measuring a channel of symbols received through a multicarrier channel and detecting P subcarriers in which a signal to noise ratio (SNR) is relatively low among N subcarriers, the P subcarriers providing a cyclic prefix (CP) of a data symbol assigned to remaining subcarriers; and transmitting position information of the P subcarriers.

The above and other aspects of the present invention can also be achieved by an apparatus for transmitting a signal in an orthogonal frequency division multiplexing (OFDM) communication system, comprising a selected-pilot subcarrier generator for assigning pilot subcarriers corresponding to P subcarriers in which a signal to noise ratio (SNR) is relatively low among N subcarriers; a mapper for mapping the pilot subcarriers to a pilot symbol and mapping remaining subcarriers to a data symbol; and a first inverse fast Fourier transform (IFFT) processor for performing an IFFT operation on a mapped signal.

The above and other aspects of the present invention can also be achieved by an apparatus for receiving a signal in an orthogonal frequency division multiplexing (OFDM) communication system, comprising a channel measurer for measuring a channel of symbols received through a multicarrier channel; and a pilot subcarrier selector for detecting P subcarriers in which a signal to noise ratio (SNR) is relatively low among N subcarriers and transmitting position information of the P subcarriers, the P subcarriers providing a cyclic prefix (CP) of a data symbol assigned to remaining subcarriers.

### BRIEF DESCRIPTION OF THE DRAWINGS

The above and other aspects and advantages of the present invention will be more clearly understood from the following detailed description taken in conjunction with the accompanying drawings, in which:

FIGS. 1A and 1B are block diagrams illustrating a transmitter and receiver respectively for transmitting and receiving a multicarrier signal using a conventional adaptive modulation scheme;

FIG. 2 illustrates multicarrier signals successively transmitted using a known cyclic prefix (CP);

FIGS. 3A and 3B are block diagrams illustrating a transmitter and receiver respectively of a multicarrier transmission system for performing adaptive modulation using a known CP in accordance with an embodiment of the present invention;

FIG. 4 is a block diagram illustrating a selected-pilot subcarrier generator for generating a known CP in accordance with an embodiment of the present invention;

FIG. 5 illustrates a process for performing pilot subcarrier synchronization and data transmission in the multicarrier transmission system based on adaptive modulation using a known CP in accordance with an embodiment of the present invention; and

FIG. 6 is a flow chart illustrating the operation of the selected-pilot subcarrier generator of FIG. 3A in accordance with an embodiment of the present invention.

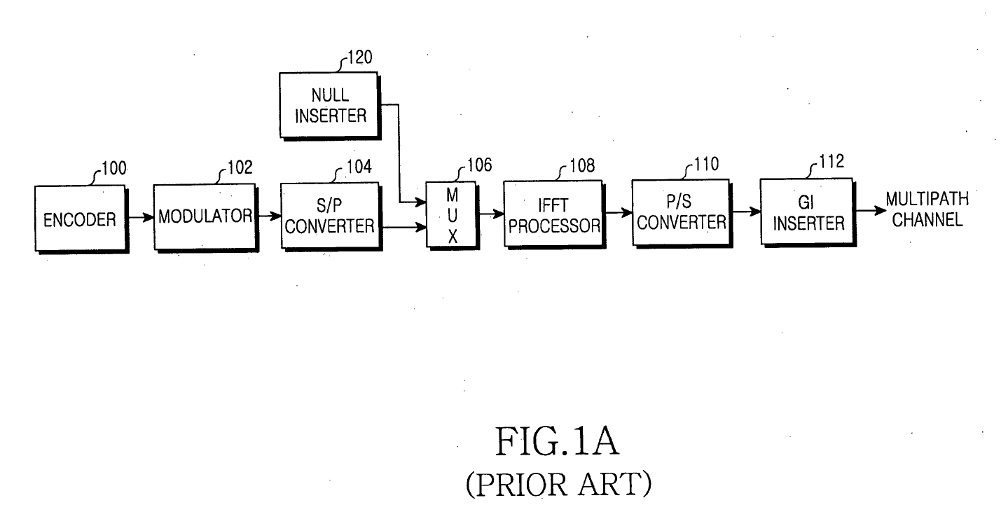

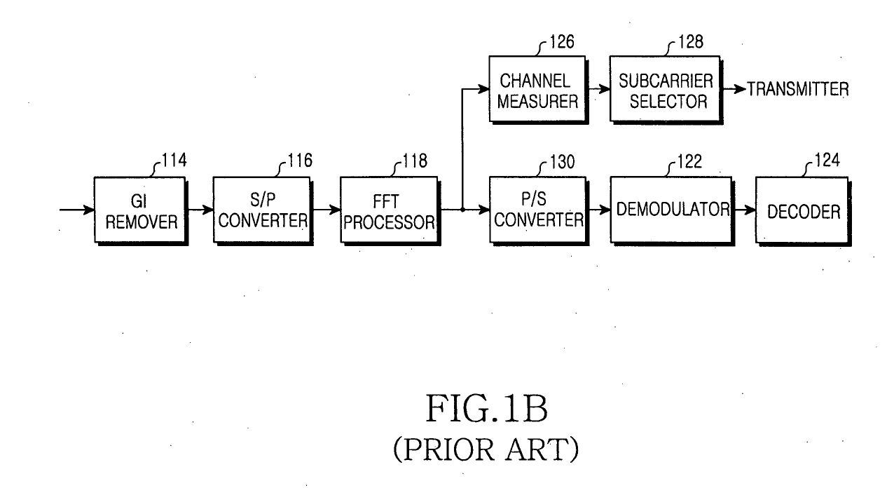

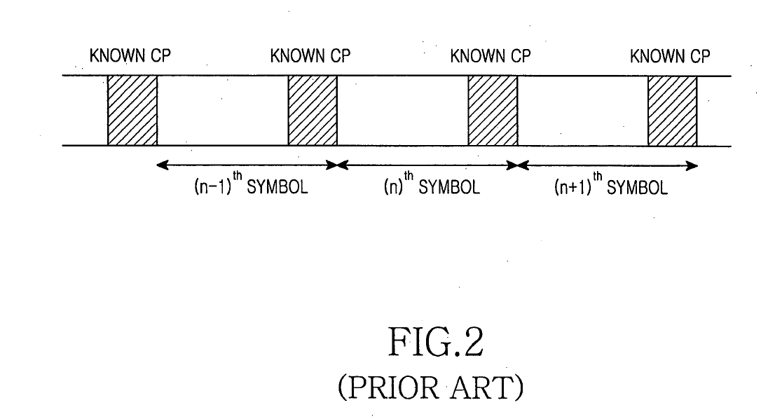

Throughout the drawings, the same or similar elements, features and structures are represented by the same reference numerals.

### DETAILED DESCRIPTION OF EXEMPLARY EMBODIMENTS

Exemplary embodiments of the present invention will be described in detail herein below with reference to the accompanying drawings. In the following description, detailed descriptions of functions and configurations incorporated herein that are well known to those skilled in the art are omitted for clarity and conciseness. It is to be understood that the phraseology and terminology used herein are used for the purpose of description and should not be regarded as limiting.

The embodiments of the present invention provide a data transmission method for minimizing inter-symbol interference (ISI) such as interference between symbols transmitted through multiple paths in an orthogonal frequency division multiplexing/code division multiple access (OFDM/CDMA) communication system. Accordingly, embodiments of the present invention generate a known cyclic prefix (CP) to avoid the ISI while considering a state of a channel through which data is transmitted. In this case, pilot subcarriers for generating the known CP are variably selected according to a channel state, and position information of the selected pilot subcarriers is fed back to a transmitter.

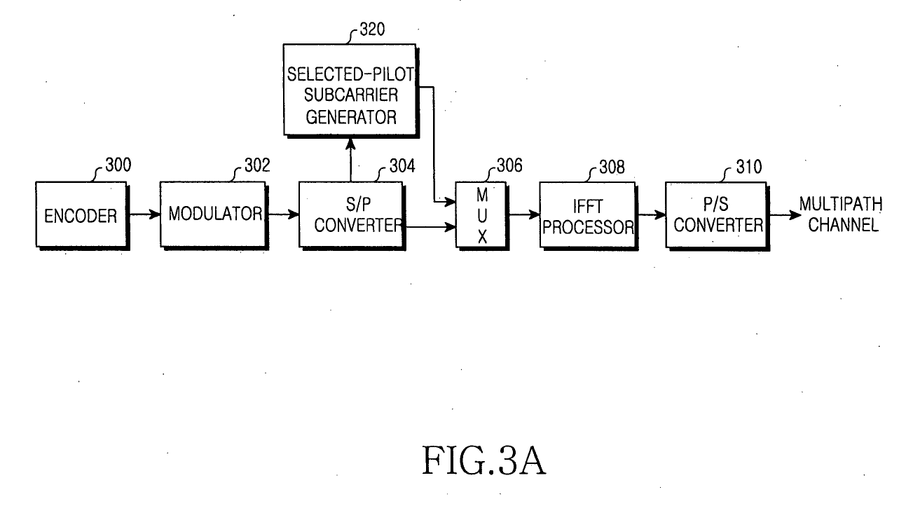

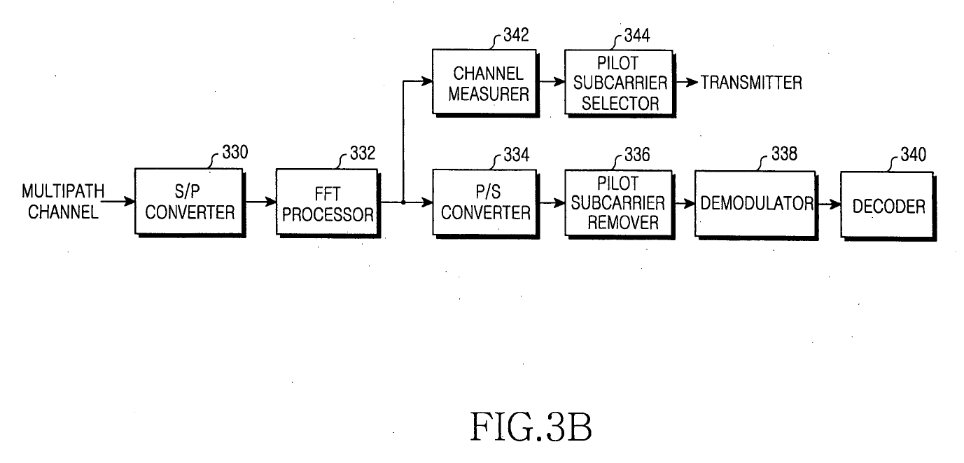

FIGS. 3A and 3B are block diagrams illustrating a transmitter and receiver respectively of a multicarrier transmission system for performing adaptive modulation using a known CP in accordance with an embodiment of the present invention.

In FIG. 3A, an encoder 300 of the transmitter receives an input of a data symbol to be configured by spread N-sample data, spreads the input data symbol using a code with a rate that is a multiple of N, and outputs the spread data symbol. A modulator 302 modulates the spread data symbol, and a serial to parallel (S/P) converter 304 converts the modulated spread data symbol into N-sample data. A selected-pilot subcarrier generator 320 uses pilot subcarriers of selected positions as a known CP in the N-sample data according to feedback information.

A multiplexer (MUX) 306 multiplexes the pilot subcarriers of the selection positions and the sample data (corresponding to the number of selected pilot subcarriers N) output from the S/P converter 304.

An inverse fast Fourier transform (IFFT) processor 308 performs IFFT, that is, OFDM modulation, on the N-sample data and outputs OFDM data of N samples in the parallel fashion. The IFFT processor 308 generates the known CP using the pilot subcarriers of the selected positions. A parallel to serial (P/S) converter 310 receives the parallel OFDM sample data from the IFFT processor 308, converts the received data in serial fashion, and outputs the serial data. The OFDM data of N samples is transmitted as an OFDM signal through multiple paths.

In FIG. 3B, a serial to parallel (S/P) converter 330 of the receiver receives the OFDM signal transmitted through a multipath channel, separates the received OFDM signal into OFDM data of N samples, and outputs the N-sample data in parallel fashion. A fast Fourier transform (FFT) processor 332 receives the N-sample data input in parallel fashion, performs FFT, that is, OFDM demodulation, and outputs the demodulated N-sample data. A parallel to serial (P/S) converter 334 converts the N-sample data in serial fashion and then outputs the converted data in a symbol unit. Because data of pilot subcarriers of selected positions are not modulated, a pilot subcarrier remover 336 removes the pilot subcarriers of the selected positions. A demodulator 338 demodulates N-P data samples of a data symbol from which the pilot subcarriers of the selected positions have been removed. A decoder 340 decodes the demodulated data symbol and identifies actual data.

A channel measurer 342 measures a channel state of the N-sample data output through the FFT processor 332. Accordingly, a pilot subcarrier selector 344 selects P subcarriers in which a signal to noise ratio (SNR) is relatively low from the measured result of the channel measurer 342 and then feeds back position information of the selected P subcarriers to the transmitter. For a known CP, the pilot subcarrier selector 344 does not select pilot subcarriers of fixed positions, but selects pilot subcarriers of variable positions while considering a channel state. Data is transmitted according to the channel state and therefore adaptive modulation is efficiently implemented.

For synchronization between the transmitter and the receiver, a pilot subcarrier pattern can be selected as follows.

First, P subcarriers of arbitrary positions in which a SNR is relatively low can be selected. In this case, adaptive modulation performance is very superior. However, there is a drawback in that signaling load increases as position information of pilot subcarriers present in different positions is transmitted.

Second, P successive subcarriers in which a SNR is relatively low can be selected. As compared with the first method, the second method reduces adaptive modulation performance, and reduces the signaling load when transmitting position information of the pilot subcarriers.

Third, M (M=P/Q) groups can be selected from Q successive subcarrier groups in which a SNR is relatively low. According to adaptive modulation performance and synchronization control, the complexity of information transmission in the third method is at the middle level between complexity levels of the first and second methods.

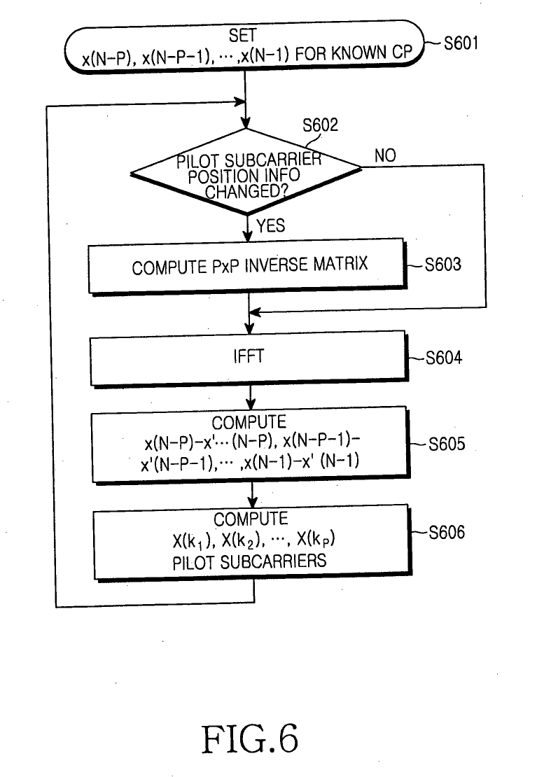

FIG. 6 is a flow chart illustrating the operation of the selected-pilot subcarrier generator of FIG. 3A. Now, the operation of the selected-pilot subcarrier generator will be described with reference to FIG. 6.

P samples x(N−P),x(N−P−1), . . . ,x(N−1) for a known CP are set at step S601, and a determination is made as to whether pilot subcarrier position information has been changed at step S602.

If the pilot subcarrier position information has been changed as a result of the determination at step S602, the pilot subcarrier generator computes a P×P inverse matrix using the changed pilot subcarrier position information k₁,k₂, . . . ,kₚ at step S603, and computes values of x′(N−P),x′(N−P−1), . . . ,x′(N−1) using IFFT after setting values of pilot subcarriers X(k₁),X(k₂), . . . ,X(kₚ) output from the S/P converter to 0 at step S604.

However, if the pilot subcarrier position information has not been changed as a result of the determination at step S602, step S603 is omitted and step S604 is performed.

After the IFFT is performed at step S604, values of x(N−P)−x′(N−P),x(N−P−1)−x′(N−P−1), . . . ,x(N−1)−x′(N−1) are computed by subtracting the values of x′(N−P),x′(N−P−1), . . . ,x′N−1) obtained by the IFFT from the values of x(N−P),x(N−P−1), . . . ,x(N−1) at step S605.

The computed P×P inverse matrix is multiplied by a matrix of P values x(N−P)−x′(N−P),x(N−P−1)−x′(N−P−1), . . . ,x(N−1)−x′(N−1) and then a result of the multiplication is multiplied by N, such that P pilot subcarriers X(k₁),X(k₂), . . . ,X(kₚ) are computed at step S606.

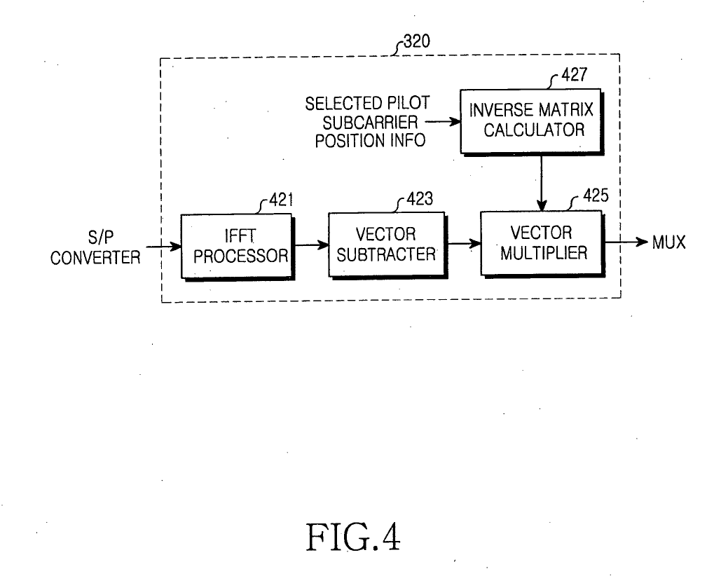

FIG. 4 is a block diagram illustrating the selected-pilot subcarrier generator for generating a known CP in accordance with an embodiment of the present invention.

The conventional known-CP setup method uses P subcarriers in fixed positions spaced at an interval of M (=N/P) subcarriers as pilot subcarriers for CP generation, where N denotes the number of symbols of an IFFT or FFT processor and P denotes the number of pilot subcarriers.

However, the embodiments of the present invention generate a known CP by selecting the P pilot subcarriers X(k₁),X(k₂), . . . ,X(kₚ) in positions in which a SNR is relatively low.

In FIG. 4, the N-sample data output from the S/P converter 304 in the parallel fashion is input to the selected-pilot subcarrier generator 320.

The selected-pilot subcarrier generator 320 does not generate a known CP in fixed positions of pilot subcarriers, but set pilot subcarriers for a known CP according to feedback position information. That is, the known CP in accordance with an embodiment of the present invention does not use pilot subcarriers of fixed positions, but is variably generated.

An IFFT processor 421 converts parallel OFDM signals output from the S/P converter into time domain signals, and detects time domain signals associated with a CP position.

A vector subtracter 423 performs a subtraction operation between values of the detected time domain signals associated with a CP position and values of a CP with a predetermined size, and generates a vector representing a CP to be inserted on the time axis.

An inverse matrix calculator 427 defines pilot subcarriers on the frequency axis using feedback position information of the pilot subcarriers such that the CP is arranged in a designated position on the time axis.

A vector multiplier 425 outputs a pilot value vector in the frequency domain by multiplying a vector output from the vector subtracter 423 and a vector output from the inverse matrix calculator 427.

In this case, the pilot subcarriers to be inserted in the frequency domain can be expressed as shown in Equation (6):

$$x ( n ) - \frac{1}{N} {\sum }_{{k ∉ \{ {k}_{1} , {k}_{2} , … , {k}_{P} \}}^{k = 0}}^{N - 1} X ( k ) {ⅇ}^{j \frac{2 π nk}{N}} = \frac{1}{N} {\sum }_{i = 1}^{P} X ( {k}_{i} ) {ⅇ}^{j \frac{2 π nki}{N}} , \\ n = N - P , … , N - 1 \\ 0 \leq {k}_{1} , {k}_{2} , … , {k}_{P} \leq N - 1 \qquad Equation ( 6 )$$

In the inverse matrix calculator 427, the P pilot subcarriers X(k₁),X(k₂), . . . ,X(kₚ) can be expressed using the inverse matrix as shown in Equation (7):

$$[ \begin{matrix}X ( {k}_{1} ) \\ ⋮ \\ X ( {k}_{P} )\end{matrix} ] = {N [ \begin{matrix}{ⅇ}^{j \frac{2 π ( N - P ) {k}_{1}}{N}} & ⋯ & {ⅇ}^{j \frac{2 π ( N - P ) {k}_{P}}{N}} \\ ⋮ & ⋰ & ⋮ \\ {ⅇ}^{j \frac{2 π ( N - 1 ) {k}_{1}}{N}} & ⋯ & {ⅇ}^{j \frac{2 π ( N - 1 ) {k}_{P}}{N}}\end{matrix} ]}^{- 1} \\ [ \begin{matrix}\begin{matrix}x ( N - P ) - {x}^{′} ( N - P ) \\ ⋮\end{matrix} \\ x ( N - P ) - {x}^{′} ( N - 1 )\end{matrix} ] \qquad Equation ( 7 )$$

A known CP may use the first P samples x(0),x(1), . . . ,x(N−P−1) instead of the last P samples x(N−P),x(N−P−1), . . . ,x(N−1) in an OFDM symbol. In this case, Equation (7) can be rewritten as Equation (8):

$$[ \begin{matrix}X ( {k}_{1} ) \\ ⋮ \\ X ( {k}_{P} )\end{matrix} ] = {N [ \begin{matrix}1 & ⋯ & 1 \\ ⋮ & ⋰ & ⋮ \\ {ⅇ}^{j \frac{2 π ( N - P - 1 ) {k}_{1}}{N}} & ⋯ & {ⅇ}^{j \frac{2 π ( N - P - 1 ) {k}_{P}}{N}}\end{matrix} ]}^{- 1} \\ [ \begin{matrix}\begin{matrix}x ( 0 ) - {x}^{′} ( 0 ) \\ ⋮\end{matrix} \\ x ( N - P - 1 ) - {x}^{′} ( N - P - 1 )\end{matrix} ] \qquad Equation ( 8 )$$

The P pilot subcarriers X(k₁),X(k₂), . . . ,X(kₚ) in which a SNR is relatively low due to small frequency response magnitude are not transmitted through data modulation using frequency selective fading characteristics of a multipath channel, but are exploited as pilot subcarriers for CP generation as shown in Equation (8). In this case, the remaining N-P subcarriers are modulated at the same level or are modulated at different levels according to SNRs. The modulated subcarriers are transmitted.

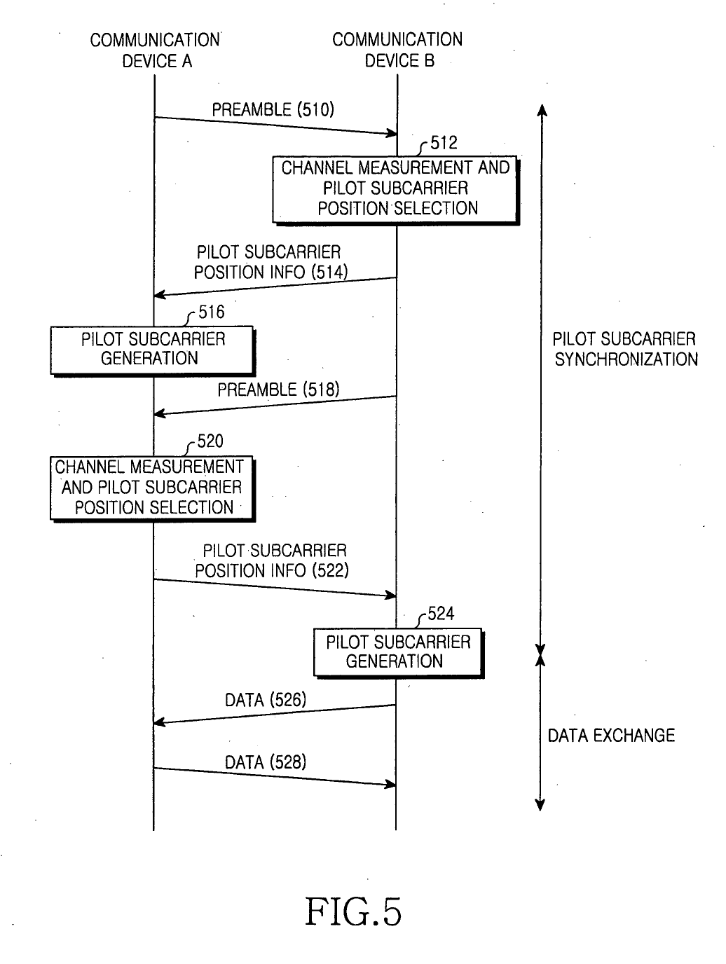

FIG. 5 illustrates a process for performing pilot subcarrier synchronization and data transmission in the multicarrier transmission system based on adaptive modulation using a known CP in accordance with an embodiment of the present invention.

Referring to FIG. 5, Communication Device A sends a preamble in step 510. Then, Communication Device B measures a channel using the received preamble and selects positions of P pilot subcarriers in which a SNR is relatively low from the measured channel in step 512.

In step 514, Communication Device B feeds back selected pilot subcarrier position information to Communication Device A.

In step 516, Communication Device A identifies a CP of data to be transmitted through pilot subcarriers of associated positions using the feedback pilot subcarrier position information.

On the contrary, Communication Device B sends a preamble to Communication Device A in step 518. Then, Communication Device A measures a channel using the received preamble and selects positions of P pilot subcarriers in which a SNR is relatively low from the measured channel in step 520.

In step 522, Communication Device A feeds back selected pilot subcarrier position information to Communication Device B. In step 524, Communication Device B identifies a CP of data to be transmitted through pilot subcarriers of associated positions using the feedback pilot subcarrier position information.

When pilot subcarrier synchronization for CP generation is established between Communication Devices A and B, data is transmitted using an OFDM scheme in steps 526 and 528.

For example, when geographic locations of the transmitter and receiver are fixed, a wireless channel state is almost constant. Accordingly, pilot subcarrier position synchronization between the transmitter and the receiver is determined at an initial connection time. Because the operation of an inverse matrix calculator is performed only once at the initial connection time, complexity can decrease.

However, when the transmitter and receiver are moving at high speed and a channel state is changed every OFDM symbol, a pilot subcarrier position is changed every OFDM symbol and also the position synchronization between the transmitter and the receiver must be updated every OFDM symbol.

In this case, overhead to be used to transmit pilot subcarrier position information for synchronization is very large. Because channel measurement and inverse matrix computation must be performed every OFDM symbol, the complexity increases. However, when the transmitter and receiver are moving at medium speed and a channel state is not changed often, a pilot subcarrier position can be updated at a predetermined time interval or in a frame unit.

In the above-described pilot subcarrier generator of an embodiment of the present invention, the complexity of the inverse matrix calculator differs according to the number of selected pilot subcarriers, and more specifically according to how often a pilot subcarrier position is changed.

That is, the pilot subcarrier position selection determines the complexity of a multicarrier system. This is closely related to a state of a transmitted channel. From the embodiments of the present invention, it can be found that the efficiency of data transmission based on OFDM modulation can be provided as a known CP is generated using selected pilot subcarriers on the basis of a channel state.

As is apparent from the above description, the embodiments of the present invention have the following advantage.

The present invention can maximize data transmission performance of an OFDM transmission system by using frequency selective fading characteristics of a multipath channel and generating pilot subcarriers for a know CP in which a SNR is relatively low due to small frequency response magnitude.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for transmitting a signal in an orthogonal frequency division multiplexing (OFDM) communication system, comprising the steps of:
assigning pilot subcarriers corresponding to P subcarriers in which a signal to noise ratio (SNR) is relatively low among N subcarriers, where N is an integer greater than 1 and P is an integer less than N; and
performing inverse fast Fourier transform (IFFT) and transmission after mapping the pilot subcarriers to a pilot symbol and mapping remaining subcarriers to a data symbol.

2. The method of claim 1, wherein the P subcarriers are selected in arbitrary positions or successive positions, or is one of M (=P/Q) groups selected from Q successive subcarrier groups, wherein Q is an integer less than M.

3. The method of claim 1, wherein the P subcarriers are used for a time domain cyclic prefix (CP).

4. The method of claim 2, wherein the P subcarriers are used for a time domain cyclic prefix (CP).

5. The method of claim 3, wherein the step of assigning the pilot subcarriers comprises the steps of:
converting parallel signals to be transmitted into time domain signals;
detecting time domain signals associated with a CP position from the time domain signals;
performing a subtraction operation between the detected time domain signals associated with the CP position and predetermined CP values and generating a vector representing the CP to be inserted on a time axis;
generating a matrix for defining pilot subcarrier positions on a frequency axis using feedback pilot subcarrier position information such that the CP is arranged in a designated position on the time axis; and
multiplying the vector and the matrix and outputting a vector of pilot values to be inserted in a frequency domain.

6. The method of claim 4, wherein the step of assigning the pilot subcarriers comprises the steps of:
converting parallel signals to be transmitted into time domain signals;
detecting time domain signals associated with a CP position from the time domain signals;
performing a subtraction operation between the detected time domain signals associated with the CP position and predetermined CP values and generating a vector representing the CP to be inserted on a time axis;
generating a matrix for defining pilot subcarrier positions on a frequency axis using feedback pilot subcarrier position information such that the CP is arranged in a designated position on the time axis; and
multiplying the vector and the matrix and outputting a vector of pilot values to be inserted in a frequency domain.

7. The method of claim 1, wherein the subcarriers mapped to the data symbol are modulated at an identical level or are modulated at different levels according to SNRs.

8. A method for receiving a signal in an orthogonal frequency division multiplexing (OFDM) communication system, comprising the steps of:
measuring a channel of symbols received through a multicarrier channel and detecting P subcarriers in which a signal to noise ratio (SNR) is relatively low among N subcarriers, the P subcarriers providing a cyclic prefix (CP) of a data symbol assigned to remaining subcarriers; and
transmitting position information of the P subcarriers.

9. The method of claim 8, wherein the P subcarriers are selected in arbitrary positions or successive positions, or is one of M (=P/Q) groups selected from Q successive subcarrier groups.

10. The method of claim 8, wherein the P subcarriers are used for a time domain CP.

11. The method of claim 9, wherein the P subcarriers are used for a time domain CP.

12. An apparatus for transmitting a signal in an orthogonal frequency division multiplexing (OFDM) communication system, comprising:
a selected-pilot subcarrier generator for assigning pilot subcarriers corresponding to P subcarriers in which a signal to noise ratio (SNR) is relatively low among N subcarriers;
a mapper for mapping the pilot subcarriers to a pilot symbol and mapping remaining subcarriers to a data symbol; and
a first inverse fast Fourier transform (IFFT) processor for performing an IFFT operation on a mapped signal.

13. The apparatus of claim 12, wherein the P subcarriers are selected in arbitrary positions or successive positions, or is one of M (=P/Q) groups selected from Q successive subcarrier groups.

14. The apparatus of claim 12, wherein the P subcarriers are used for a time domain CP.

15. The apparatus of claim 13, wherein the P subcarriers are used for a time domain CP.

16. The apparatus of claim 14, wherein the selected-pilot subcarrier generator comprises:
a second IFFT processor for converting parallel OFDM signals to be transmitted into time domain signals;
a subtracter for performing a subtraction operation between time domain signals associated with a CP position among the time domain signals and values of a CP with a predetermined size and generating a vector representing the CP to be inserted on a time axis;
an inverse matrix calculator for generating a matrix for defining pilot subcarrier positions on a frequency axis using feedback pilot subcarrier position information such that the CP is arranged in a designated position on the time axis; and
a vector multiplier for multiplying the vector and the matrix and outputting a vector of pilot values to be inserted in a frequency domain.

17. The apparatus of claim 15, wherein the selected-pilot subcarrier generator comprises:
a second IFFT processor for converting parallel OFDM signals to be transmitted into time domain signals;
a subtracter for performing a subtraction operation between time domain signals associated with a CP position among the time domain signals and values of a CP with a predetermined size and generating a vector representing the CP to be inserted on a time axis;
an inverse matrix calculator for generating a matrix for defining pilot subcarrier positions on a frequency axis using feedback pilot subcarrier position information such that the CP is arranged in a designated position on the time axis; and
a vector multiplier for multiplying the vector and the matrix and outputting a vector of pilot values to be inserted in a frequency domain.

18. An apparatus for receiving a signal in an orthogonal frequency division multiplexing (OFDM) communication system, comprising:
a channel measurer for measuring a channel of symbols received through a multicarrier channel; and
a pilot subcarrier selector for detecting P subcarriers in which a signal to noise ratio (SNR) is relatively low among N subcarriers and transmitting position information of the P subcarriers, the P subcarriers providing a cyclic prefix (CP) of a data symbol assigned to remaining subcarriers.

19. The apparatus of claim 18, wherein the P subcarriers are selected in arbitrary positions or successive positions, or is one of M (=P/Q) groups selected from Q successive subcarrier groups.

20. The apparatus of claim 18, wherein the P subcarriers are used for a time domain CP.

21. The apparatus of claim 19, wherein the P subcarriers are used for a time domain CP.
